(19) United States
(12) Patent Application Publication
(10) Pub. No.: US 2022/0084370 A1
(43) Pub. Date: Mar. 17, 2022

(54) ATM SUPPORT

(71) Applicant: EMSN Initiative & Resolutions 2013 Ltd.

(72) Inventors: Shmuel NEUFELD, LOD (IL); Elazar MEDZINSKI, NETA (IL)

(73) Assignee: EMSN Initiative & Resolutions 2013 Ltd., Lod (IL)

(21) Appl. No.: 17/471,299

(22) Filed: Sep. 10, 2021

Related U.S. Application Data
(60) Provisional application No. 63/077,664, filed on Sep. 13, 2020.

(51) Int. Cl. G07F 19/00; F16M 1/00

(52) U.S. Cl. CPC G07F 19/205; F16M 1/00

(57) ABSTRACT

An ATM support for an ATM having an ATM fascia. The ATM support includes an ATM height adjustment mechanism configured to allow the ATM to be raised and lowered; and an ATM horizontal adjustment mechanism configured to allow the ATM to be moved back and forth horizontally, whereby the height and horizontal position of the ATM fascia can be adjusted to correspond to an opening in an ATM receiving structure.

### FIELD OF THE TECHNOLOGY

The present invention is in the field of automated cash machines, in particular a case (support) configured to adjust the position of the ATM screen and a mechanism for rotating a front-loading cash dispenser box for loading of cash from the rear of the ATM.

### BACKGROUND OF THE TECHNOLOGY

Automatic teller machines (ATMs) can provide continual and automated cash withdrawal and deposit services, as well as other banking type services, without the need for a bank teller. ATMs are most commonly mounted in an outer wall of a bank. Such ATMs are loaded with cash from the inside of the bank, and the front of the ATM protrudes outside the wall where it is accessed by customers.

However, some ATMs are designed to be essentially inside a store or the like with only the face/fascia of the ATM exposed to the outside for money dispensing and other transactions and activities.

U.S. Pat. No. 8,723,941 (Shirbabadi, et al., 2014 May 13) discloses a handicap-accessible ATM including a display screen and at least one lifting mechanism. The lifting mechanism may operate to change the vertical height of the display screen relative to the user's eyes.

### SUMMARY

The present invention relates to an automated teller machine (ATM) with an adjustable case (support) configured to facilitate vertical and horizontal adjustment of the ATM, which can help installation of the ATM in a wall; and a money-loading mechanism for the ATM. The money-loading mechanism facilitates convenient cash loading via the rear of the ATM, while incorporating a load drawer of an ATM with a front-loading money drawer.

In accordance with embodiments of one aspect of the present invention, there is provided an ATM support configured to adjust the height and horizontal position of an ATM fascia. The ATM support includes [to be completed when Claims are finalized]

The adjustable support/case, and its adjustment mechanism to allow adjustment and fixing of the ATM fascia position, is particularly useful for, but not limited to, providing flexibility in locating the fascia of the ATM at a proper position for installation, which can save installation labor, materials and time, as well as reduce interruption to a business where the ATM is installed.

### BRIEF DESCRIPTION OF THE DRAWINGS

The invention may be more clearly understood upon reading of the following detailed description of non-limiting exemplary embodiments thereof, with reference to the accompanying drawings.

FIG. 1 is a rear perspective view of an ATM including an ATM support in accordance with embodiments of the present invention.

FIG. 2 is a partially exploded perspective view of a vertical/height adjustment mechanism of an ATM support of the ATM of FIG. 1 in accordance with embodiments thereof.

FIG. 3 is a perspective view of FIG. 2 with the vertical/height adjustment mechanism of ATM support in a lowered position.

FIG. 4 is a view of FIG. 3 with the vertical/height adjustment mechanism of ATM support in a raised position.

FIG. 5 is a perspective view of the ATM support illustrating a horizontal adjustment mechanism thereof in a partially extended position.

FIGS. 6 and 7 are perspective views of the ATM support, as in FIG. 6, illustrating a horizontally slidable member thereof configured to accommodate a cash dispenser box.

FIG. 8 is a front view of the ATM support.

FIG. 9 is a view of FIG. 1 illustrating the cash box in a rearward position.

FIG. 10 is an enlarged view of a portion of FIG. 9.

FIG. 11 is a perspective view of the present ATM support including a cash-box rotation mechanism in accordance with embodiments thereof.

FIG. 12 is a perspective view showing an exemplary ATM fascia of an ATM while being supported by the present ATM support.

The following detailed description of embodiments of the invention refers to the aforementioned accompanying drawings. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

Illustrative embodiments of the invention are described below. In the interest of clarity, not all features/components of an actual implementation are necessarily described.

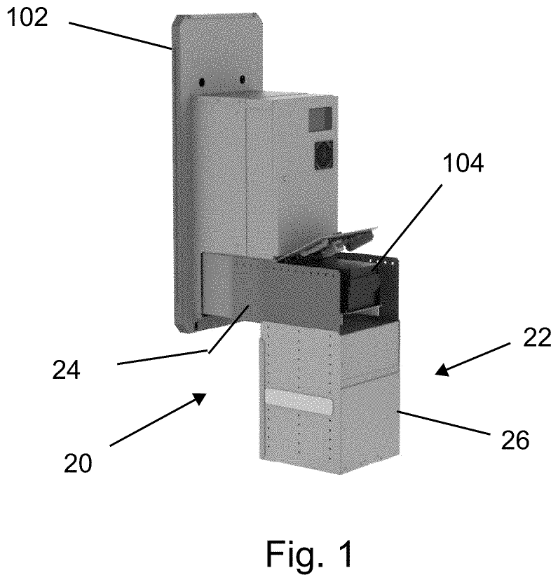

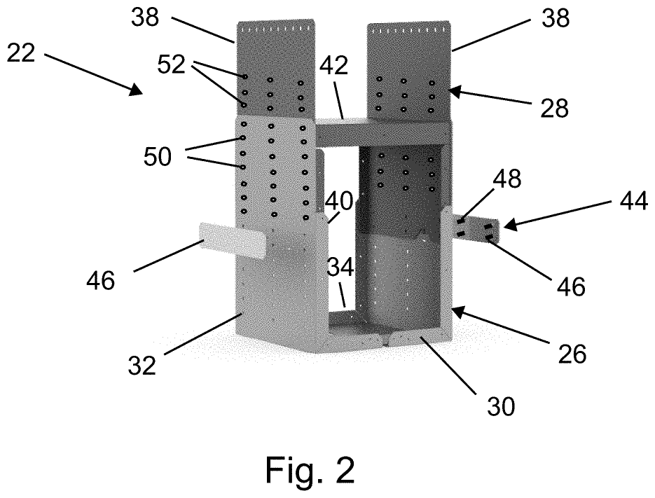

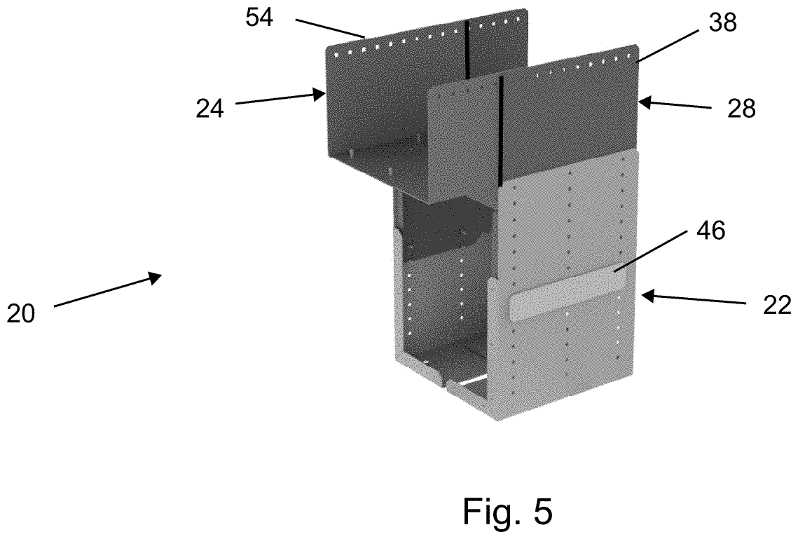

FIG. 1 shows an exemplary automated teller machine (ATM) 100 with an ATM fascia 102 and a cash dispenser box 104, supported by an ATM support 20, in accordance with embodiments of the present invention. ATM support 20 is configured to allow both height (vertical) and back and forth (horizontal) positioning flexibility and fixing. As such, ATM support 20 includes a vertical/height adjustment mechanism 22 (FIGS. 2-4) and a horizontal adjustment mechanism 24 (FIGS. 5-7). Cash dispenser box 104 is shown in the rearward position with its cover open, ready for loading cash. ATM support 20 may be weighted and/or have a fixing mechanism (not shown) for fixing/fastening the support to the floor or a heavy pedestal.

FIG. 2 shows a vertical/height adjustment mechanism 22, including a base 26 and an upper portion 28 configured to interface and slide within the base, as illustrated; or slide outside of the base. Base 26 includes a bottom 30 and a pair of opposing sides 32. Base 26 may have upwardly facing flange-like edges 34, for mechanical strength; and sides 32 may have inwardly facing flange-like edges 36, for mechanical strength as well as to aid in interfacing with upper portion 28.

Upper portion 28 has a pair of opposing sides 38, corresponding to sides 32 of base 26. Opposing sides 38 typically have inwardly facing flange-like edges 40, for mechanical strength as well as for increased interfacing with base 26, in particular with inwardly facing flange-like edges 36 of the base. Upper portion 28 also includes a shelf 42 for supporting cash dispenser box 104. Upper portion 28 is vertically slidable with respect to base 26 (i.e. opposing sides 38) so as to allow ATM support 20 to be upwardly and downwardly adjustable in order to place ATM fascia 102 at a suitable height.

Vertical/height adjustment mechanism 22 further includes a height fixing device 44, illustrated as a pair of rectangular strips 46 with projections 48 corresponding to apertures 50 and apertures 52 in base 26 and upper portion 28, respectively. As such, upper portion 28 can be moved to a suitable height and strips 46 of height fixing device 44 can be pressed to sides 32 of base 26 so that projections 48 are received in apertures 50 and 52.

It should be understood that a variety of interfaces and fixing devices can be employed, and the above description is merely one embodiment, and not intended to be limiting.

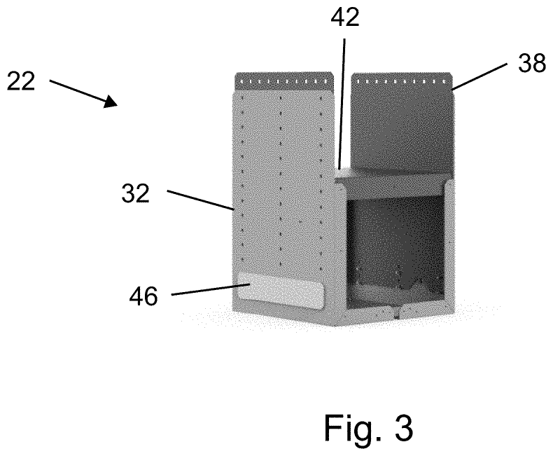

FIG. 3 shows upper portion 28 fixed in a lowered position by rectangular strips 46 of height fixing device 44. Such a lowered position can be desired if the floor is relatively high with respect to an opening within which the ATM is to be located.

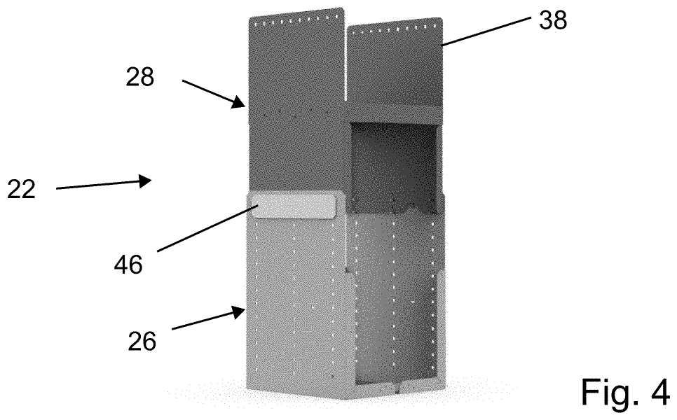

FIG. 4 shows upper portion 28 fixed in a raised position by height fixing device 44. Such a raised position can be desired if the floor is relatively low with respect to an opening within which the ATM is located.

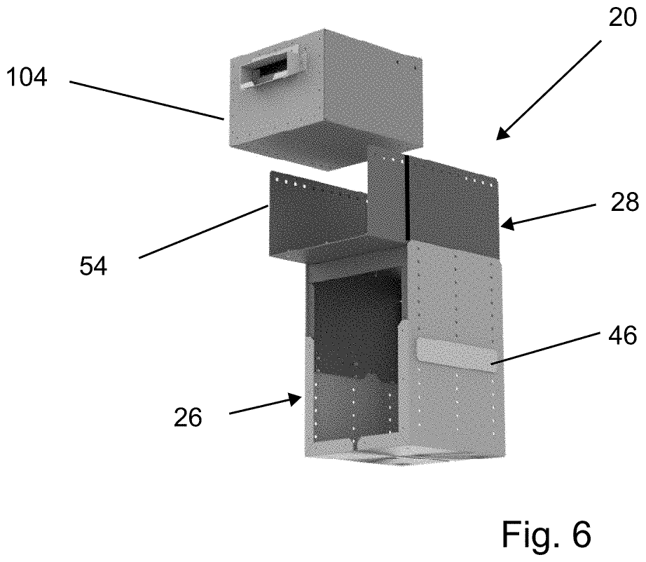

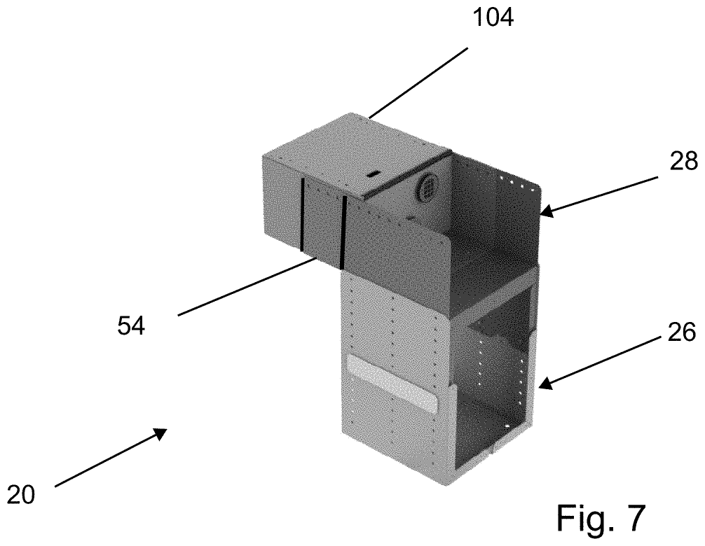

FIG. 5 shows a horizontal adjustment mechanism 24 of ATM support 20 with an exemplary horizontally slidable member 54, with the support in a horizontally extended position (as in FIG. 1). Such a horizontally extended position is useful for adjusting the ATM so that it can be located in opening in a proper position inside of walls of varying thicknesses. Horizontally slidable member 54 of horizontal adjustment mechanism 24 is dimensioned to receive cash dispenser box 104, as illustrated in FIGS. 6 and 7.

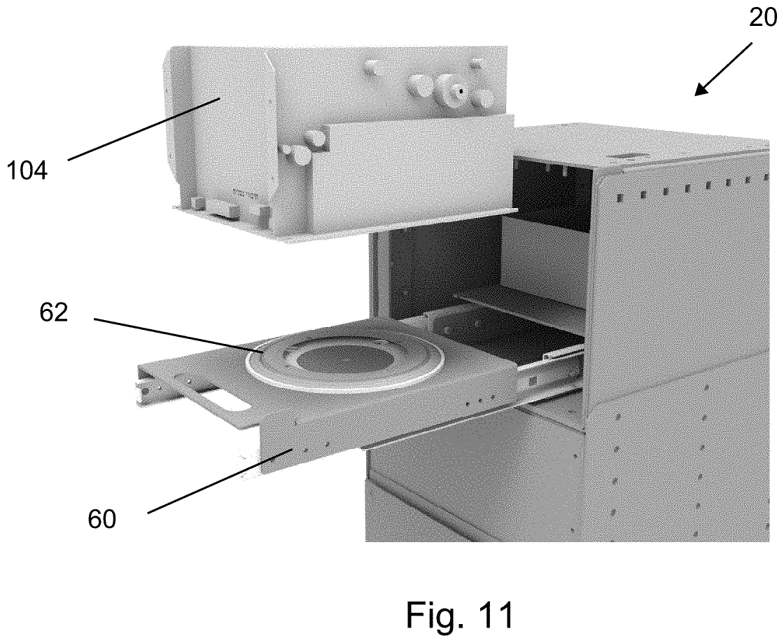

FIGS. 6 and 7 respectively show a front perspective and a rear perspective view of ATM support 20, illustrating horizontally slidable member 54 in a horizontally extended position (as in FIG. 1). Such a horizontally extended position is useful for adjusting ATM 100 so that it can be adjusted to a proper horizontal position with respect to vertical/height adjustment mechanism 22 so as to be positionable in an ATM wall opening (FIG. 11).

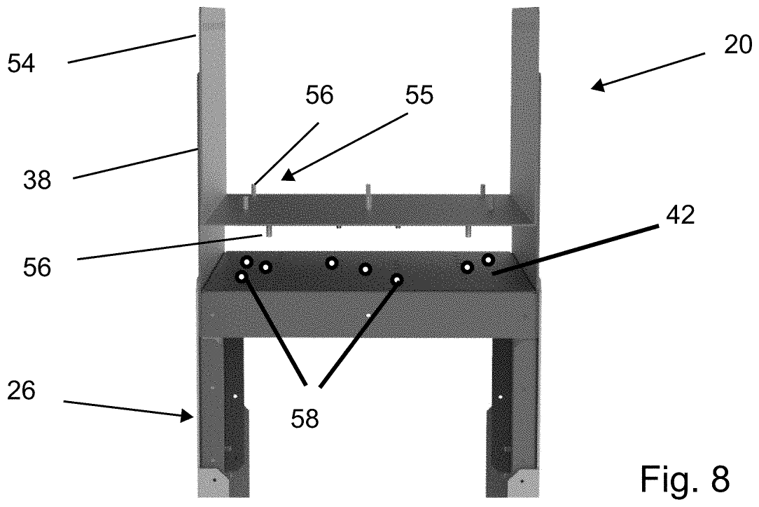

FIG. 8 shows ATM support 20 illustrating an exemplary connection mechanism 55 for fixing horizontally slidable member 54 to shelf 42, exemplified by a plurality of fastening pins 56 corresponding to apertures 58 in the shelf.

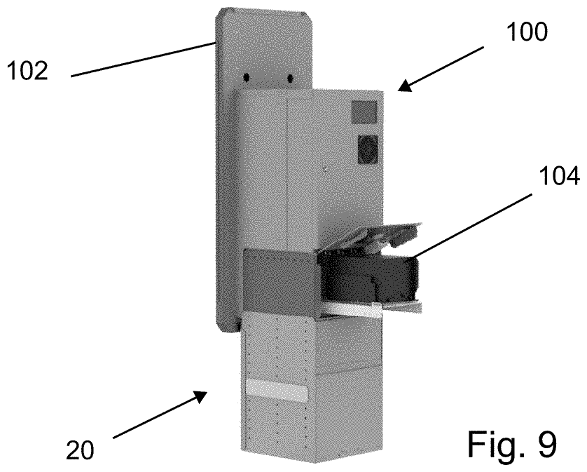

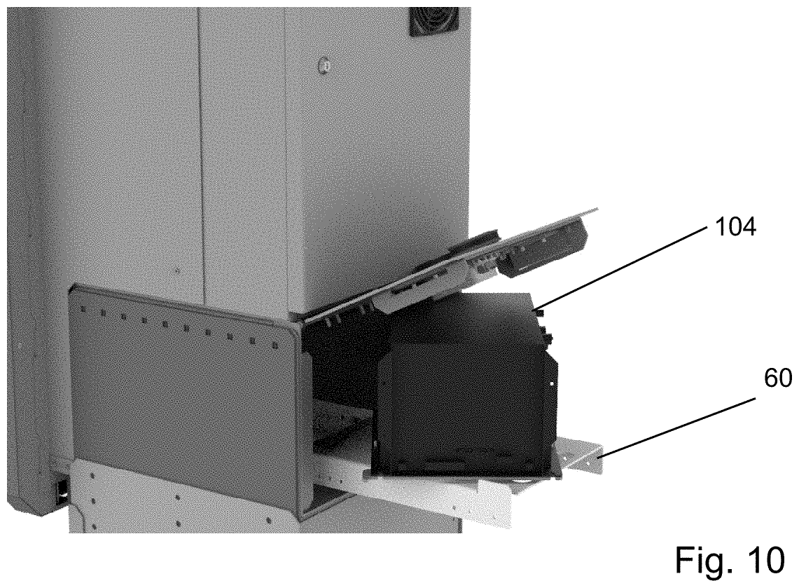

FIG. 9 shows cash dispenser box 104 slid back, i.e. a cash dispenser box shelf 60 is slid backward, from the remainder of ATM 100. As this is a front loading ATM, whose cash dispenser box 104 would thus ordinarily be loaded from its front, in order to load the dispenser cash box from the rear (i.e. the interior of the store or such location in which the ATM is installed), the cash dispenser box must be rotated to allow cash to be loaded (FIG. 10 shows the cash dispenser box partially rotated).

FIG. 11 shows a cash-box rotation mechanism including or exemplified by a turntable 62 to allow rotation of cash dispenser box 104. Turntable 62 can be configured as a manually turnable plate or to include a motor that can be, for example, actuated by pulling cash dispenser box outward, for example by pulling shelf 60 outward. This rotation mechanism provides the advantages of using a smaller dimensioned and lower cost front-loading dispenser box, with the ability to load from the rear. Front loading cash dispensers are smaller and less expensive, thereby saving space in the store (or facility where it is located.

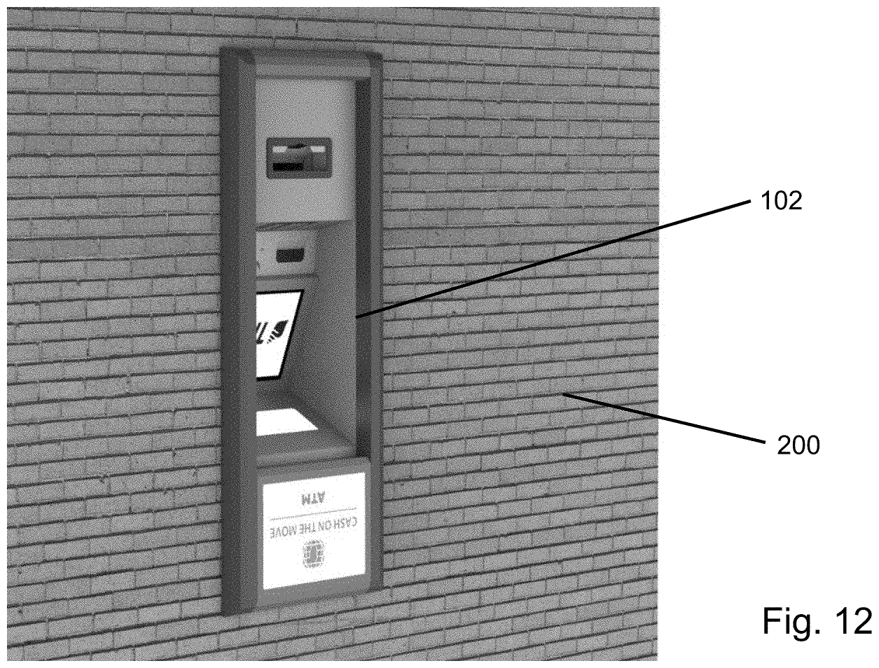

FIG. 12 is a perspective view showing ATM fascia 102 at a store wall 200 (or wall of another establishment). Due to ATM support 20 with mechanisms 22 and 24 configured to adjust the height and forward-backward movement of the ATM, the fascia can be inserted at the proper location, in accordance with requirements, including height requirements for handicapped people, such as those who use wheelchairs.

It should be understood that the above description is merely exemplary and various embodiments of the present invention may be devised, mutatis mutandis, and that the features described in the above-described embodiments, and those not described herein, may be used separately or in any suitable combination; and the invention can be devised in accordance with embodiments not necessarily described above.

1. An ATM support for an ATM having an ATM fascia, the support comprising:
an ATM height adjustment mechanism configured to allow the ATM to be raised and lowered; and
an ATM horizontal adjustment mechanism configured to allow the ATM to be moved back and forth horizontally,
whereby the height and horizontal position of the ATM fascia can be adjusted to positionally correspond to an opening in an ATM receiving structure.

2. The support of claim 1, wherein the ATM height adjustment mechanism comprises a base; an upper portion configured to interface and slide with respect to the base; and a height fixing device configured to fix the upper portion with respect to the base.

3. The support of claim 2, wherein the upper portion comprises a shelf configured to support a cash dispenser box.

4. The support of claim 1, wherein the ATM horizontal adjustment mechanism comprises a horizontally slidable member.

5. The support of claim 1, wherein the ATM horizontal adjustment mechanism is dimensioned to receive a cash dispenser box.

6. The support of claim 2, wherein the ATM horizontal adjustment mechanism is configured to slide with respect to and be fixable to the upper portion of the ATM height adjustment mechanism.

7. The support of claim 1, wherein the ATM horizontal adjustment mechanism comprises a connection mechanism comprising a plurality of fastening pins corresponding to apertures in the shelf.

8. The support of claim 1, wherein the ATM is a front-loading type ATM and the ATM support comprises a money-loading mechanism configured to facilitate cash loading via the rear of the ATM.

9. The support of claim 8, wherein the money-loading mechanism comprises a cash-box rotation mechanism with a turntable to allow rotation of a cash dispenser box.

10. The support of claim 9, wherein the turntable is configured to be manually turnable.

11. The support of claim 9, wherein the rotation mechanism comprises a motor.

12. The support of claim 11, wherein the motor is actuated by pulling the cash dispenser box outward.
